(19) United States
(12) Patent Application Publication
(10) Pub. No.: US 2011/0227531 A1
(43) Pub. Date: Sep. 22, 2011

(54) SYSTEMS AND METHODS FOR RECHARGING AN ELECTRIC VEHICLE

(76) Inventor: Joseph Rajakaruna, Santa Rosa, CA (US)

(21) Appl. No.: 12/728,241

(22) Filed: Mar. 21, 2010

(51) Int. Cl. H02J 7/00; G06Q 40/00; G05B 19/00

(52) U.S. Cl. 320/109; 320/107; 235/379; 340/5.6

(57) ABSTRACT

A recharging port for an electric vehicle includes a recharging lid having a latch to secure the recharging lid to the recharging port when the lid is closed; an arm coupled to the recharging lid to open the recharging lid; and a power receptacle recessed in the recharging port to provide power to recharge one or more batteries in the electric vehicle.

The present application relates to a recharging lid for an electric vehicle.

Automobiles such as cars and trucks have a fuel system for storage of fuels, typically gasoline which is consumed to power the vehicle. A fuel door is a door which provides a cosmetic covering to the fuel containment system. Typically, the fuel door is to be opened to provide access to a gas cap which is removable for access to a pipe leading to a gas tank and through which gasoline or other fuels may be added. The fuel door often not only provides a cosmetic covering, and may be locked so as to provide protection against unauthorized access to the fuel cap.

Manual fuel door assemblies are known which are adapted for opening manually as, for example, by a finger pull-tab being provided on the fuel door to be engaged by a user to move the fuel door between the open and closed position. Manual fuel door assemblies are also known which provide spring mechanisms to firstly, bias the fuel door to a closed position and secondly, on movement from the closed position towards the open position to bias the fuel door to the open position.

Fuel door assemblies are known which provide mechanisms for remote opening typically by providing a latch mechanism which holds the fuel door in a closed position. The latch may be unlatched from a remote location to release the fuel door. On unlatching of the latch, the fuel door may then be opened, for example, manually or more preferably under the bias of an initial pop-up spring which moves the fuel door from a closed position to either a partially open position from which it may be manually moved to a fully opened position, or to a fully open position.

Fuel door assemblies typically include a door side hinge bracket and a body side hinge bracket which are coupled together for pivoting to move the door side hinge bracket carrying a fuel door between the closed and the opened position. The present inventors have appreciated that most vehicle manufacturers use different configurations of door side hinge brackets and body side hinge brackets dependent upon the desired operational characteristics of the fuel door assembly, such as whether they may be manually opened, remotely opened and/or have springs with provide for pop-up and full or partial opening. This has a disadvantage of requiring increased parts for manufacture and increased overall costs.

U.S. Pat. No. 7,566,089 discloses a construction for a fuel door assembly in which one or more different spring members may be coupled to the same assembly to provide for different operational characteristics. A spring member is provided and incorporated as part of the assembly securing engaging the other components assembly to prevent vibration and rattling.

### SUMMARY

In one aspect, a recharging port for an electric vehicle includes a recharging lid having a latch to secure the recharging lid to the recharging port when the lid is closed; an arm coupled to the recharging lid to open the recharging lid; and a power receptacle recessed in the recharging port to provide power to recharge one or more batteries in the electric vehicle.

Implementations of the above aspect may include one or more of the following. An access control device can read authorization information from a proximity card, RFID, smart card, credit card, or pin pad code, the access control device adapted to unlock the latch to open the recharging lid and to receive power upon authorization. The access control device can also unlock a door in a recharging station to provide recharging power to the vehicle upon authorization. The access control device can be in the vehicle or on the recharging station.

In another aspect, a recharging station includes a power receptacle adapted to recharge a vehicle battery; an electrically-controlled door to control access to the power receptacle; and an access control device to open the door and to supply power to the power receptacle after authorization.

Implementations of the above aspect may include one or more of the following. The recharging station can include an indicator light coupled to the access control device to indicate authorization and activation of power to the power receptacle. A plurality of power connections can be provided to distribute electricity to charge in parallel a plurality of battery sets in a vehicle. The access control device reads a credit card and charges the credit card prior to opening the door and supplying power to the power receptacle. Alternatively, the access control device reads a smart card and charges the smart card prior to opening the door and supplying power to the power receptacle. Alternatively the access control device reads a code or password from a user and opens the door and supplies power to the power receptacle. The access control device can also read a biometric scan or a thumb print of a user and opens the door and supplies power to the power receptacle. The access control device opens a recharging lid having a latch to secure the recharging lid to the recharging port when the lid is closed, comprising a power cable coupling the power receptacle on the recharging station to a power receptacle recessed in the recharging port to provide power to recharge one or more batteries in the electric vehicle.

In another aspect, a system includes a vehicle having a recharging lid having a latch to secure the recharging lid to the recharging port when the lid is closed; an arm coupled to the recharging lid to open the lid; and a power receptacle recessed in the recharging port to provide power to recharge one or more batteries in the electric vehicle; and a recharging station, including a power receptacle adapted to recharge a vehicle battery; an electrically-controlled door to control access to the power receptacle; and an access control device to open the door and to supply power to the power receptacle after authorization.

Implementations of the above aspect may include one or more of the following. A transceiver in the recharging station can send status of components in the vehicle to a remote computer. Each set of batteries is electrically isolated during charging and electrically connected thereafter to allow parallel charging and to improve charging speed.

Advantages of the preferred embodiments may include one or more of the following. The system provides a secure method for charging an electric vehicle. Payment for the charge can be received through various payment mechanisms including smart card, credit card, change, paper money, code through a key card, biometric thumb print, among others. The charger station can be used by anyone who possesses any of the above and a manual entered pin code if a smart card is utilized. The payment can be made through a revenue generating business model that includes flexible subscriber payment methods such as “free” charging, pay per use, by subscription, and by kWh (where allowed). The payment can be validated by various members such as specific chain stores that contribute or provide free charging for the advertising and PR benefit. A pay point system can be provided where pre-paid cards may be issued by the owner or by independent vendors upon receipt of payment. The station could also provide advertising through a computer screen or wall space, also providing a means of producing income. Large chain stores such as McDonalds, Starbucks, Costco, Best Buy and the like can receive large advertising benefits from advertising on and having charge stations located in their facilities.

Once the user is recognized, the charger has an on light and automatic door opening system that activates the power to the plug. Metering of power consumption is via internal smart metering system that update remotely via the mobile phone network. The metered power can by viewed online by users/members of the system and site owner. The rate can be adjusted remotely and by time of day. The rates payable per kilowatt hour (KWH) can be viewed online. During recharge an on screen display shows how much KWH is being drawn.

The system has an anti-power piracy and security circuit in one embodiment. A sensor detects if the power cable has been cut, and power ceases. A text message is sent to the user/owner to inform there has been a power interruption. A tamper alarm will sound if security of system is violated. A resettable GFI is incorporated to allow the system to recover from power surges. When current drops to near zero a text message is sent to the owner, noting the vehicle has reached full charge.

A smart controller is provided to optimize the charging schedule to minimize cost, enhance grid stability, and to safely set the maximum battery charge rate within the electrical limits of the battery, battery charger, and premises/charging station. The charger operates in a way that utilities would prefer to have it, and EV owners would prefer to have it. The smart charger controller communicates with the battery charger, charging station/premises, display, and the battery management system to set and control when and how the vehicle's battery will be charged. Utilities can target demand and respond to event to specific areas as needed.

### BRIEF DESCRIPTION OF THE DRAWINGS

FIG. 1A shows an exemplary electric recharge lid for a vehicle.

FIG. 1B shows the lid of FIG. 1A when closed with a power line emerging from the lid to be plugged into AC line power.

FIG. 2 shows an exemplary electric van with the recharge lid of FIG. 1.

FIG. 3 shows an exemplary front view of a charging station.

FIG. 4 shows exemplary power circuitry in the vehicle.

### DESCRIPTION

Methods and apparatus that implement the embodiments of the various features of the disclosure will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

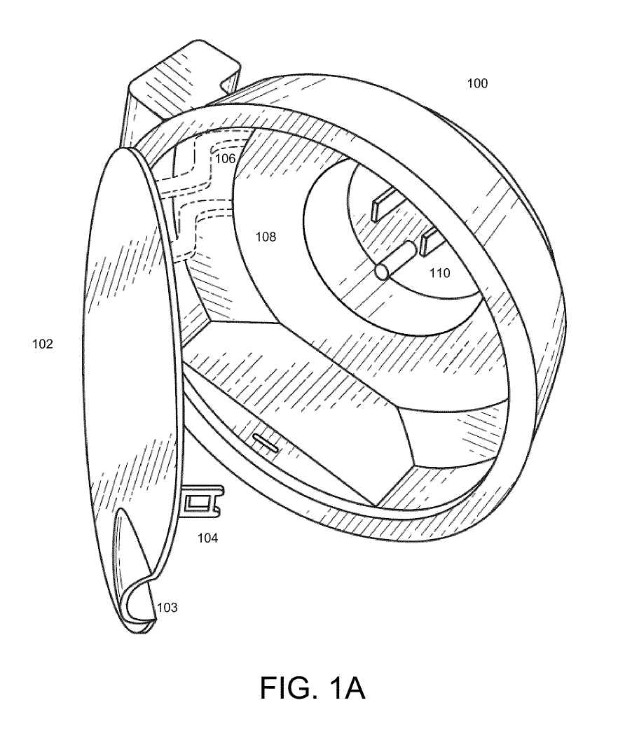

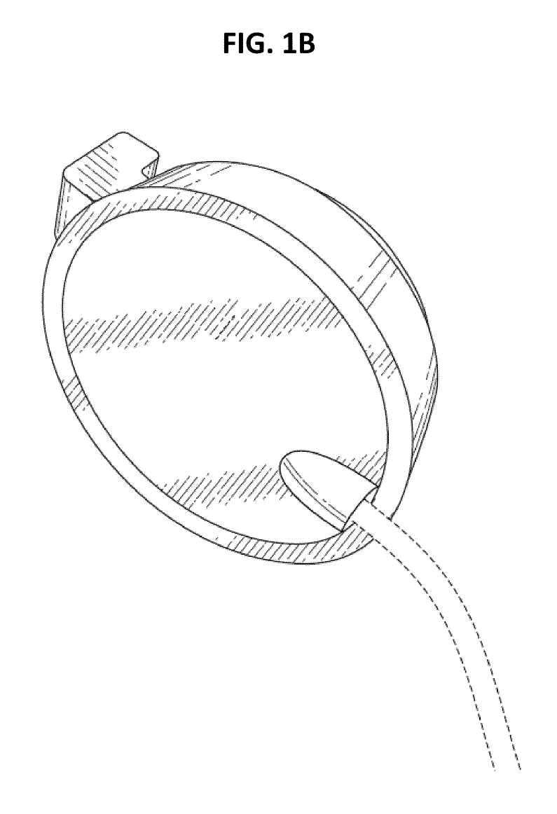

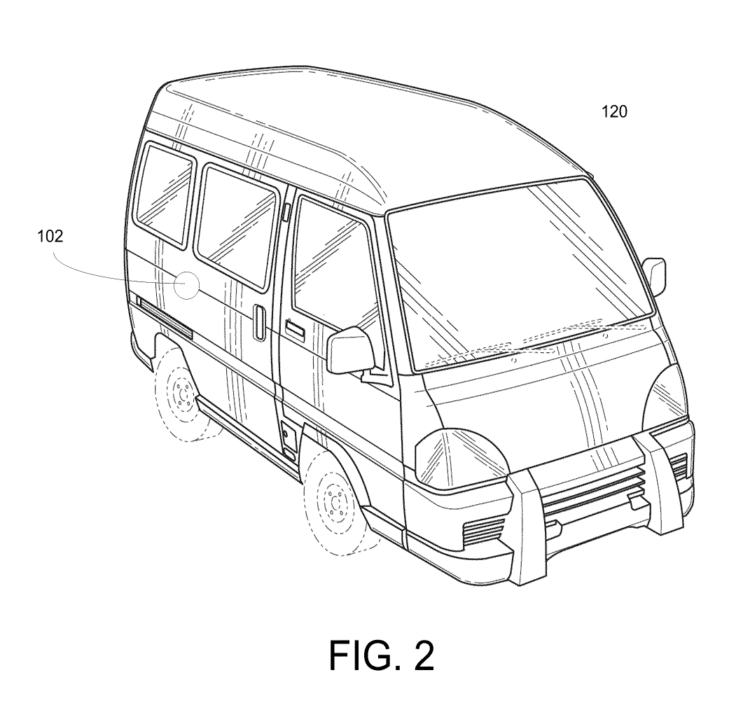

FIG. 1A shows an exemplary electric recharge lid for a vehicle, while FIG. 2 shows an exemplary electric van with the recharge lid of FIG. 1A. FIG. 1B shows the lid of FIG. 1A when closed with a power line exiting from the lid to be plugged into AC line power.

Referring now to FIG. 1A, an electric recharge port 100 includes a recharge lid 102 with a latch 104 that is manually unlocked or electrically controlled to allow the lid 102 to open. The lid 102 pivots about the port 100 through arms 106, and when activated by the driver, allows the lid 102 to pop out to allow access to an electrical receptacle 110 so that a power cable can be connected to the receptacle 110 in a recharging chamber 108. The lid 102 can be positioned on one side of a vehicle such as the vehicle of FIG. 2. A curved finger receiving space 103 on the lid 102 can receive a user's finger so that the user can move the lid into an open position. When the lid 102 is closed, the curved finger receiving space 103 allows a power line cable to access the electrical receptacle 110 when the lid 102 is closed. This provides a compact and clean surface during charging, among others.

The power cable can be a coaxial cable or a power cable and a data cable. In one embodiment, the same wire carrying power also carries data. Data in the form of radio frequency (RF) energy can be bundled on the same line that carries electrical current. Since RF and electricity vibrate on different frequencies, there is no interference between the two. As such, data packets transmitted over RF frequencies are not overwhelmed or lost because of electrical current. Eventually, the data can be provided to wireless transmitters that will wirelessly receive the signal and send the data on to computer stations. Exemplary protocols that can be used include CAN-bus, LIN-bus over power line (DC-LIN), and LonWorks power line based control. In one embodiment, the protocol is compatible with the HomePlug specifications for home networking technology that connects devices to each other through the power lines in a home. Many devices have HomePlug built in and to connect them to a network all one has to do is to plug the device into the wall in a home with other HomePlug devices. In this way, when the vehicle is recharged by plugging the home power line to the vehicle connectors, automotive data is automatically synchronized with a computer in the home or office.

Alternatively, two separate transmission media can be used: one to carry power and a second to carry data. In one embodiment, the data cable can be a fiber optic cable while the power cable can be copper cable or even copper coated with silver or gold. The data cable can also be an Ethernet cable. The data can be an Internet Protocol (IP) in the cable. Each body panel can have a battery recharger. The body panel can be made of lithium ion batteries. The batteries can have a shape that conforms to a specific shape such as a door or a hood or a seat, for example. To protect the occupant, a beam can be used that transfers a crash load into the vehicle body and away from a passenger cabin. Additionally, driver and passenger air bags positioned in the vehicle body. A wireless transceiver can be connected to the power cable. The wireless transceiver sends status of components in the vehicle to a remote computer. The wireless transceiver communicates maintenance information to a remote computer. If needed, the remote computer orders a repair part based on the maintenance information and schedules a visit to a repair facility to install the repair part.

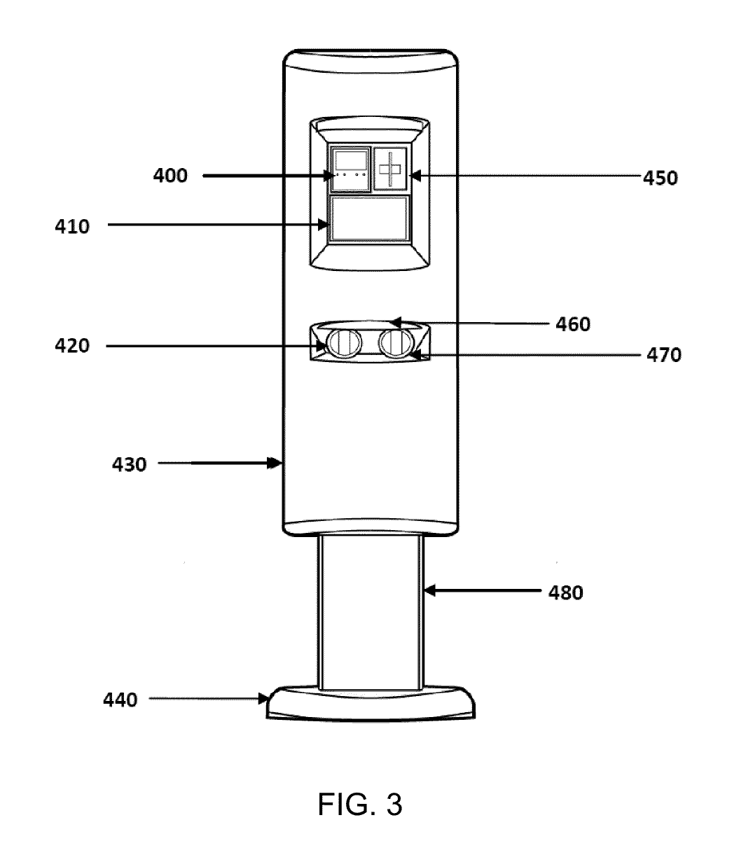

FIG. 3 shows an exemplary front view of a charging station. The charging station includes a dual fast charge port (item 420 and 470), via a pre-paid metering system 400 such as a Holley pre-paid meter. In this embodiment, the system is activated by inserting a prepaid card into the card reader 450. The Holley pre-paid meter 400 powers on and displays pre-paid card data. A main display screen 410 displays information as well as advertisements. The screen 410 can be used as a functional touch screen to select pre-paid meter options. After the chosen options are selected the dual port door 460 opens. This dual port door 460 is used secure the port from unauthorized users and secure the plug from tampering after activated. A standard 110V Port 420 is used for standard charging rate using 110V power. Fast charge Port 470 is used for fast charging at a high voltage such as 220V+. An outer casing 430 of the Charging Station securely encloses all component hardware within the unit. The outer casing 430 is placed on a solid steel mounting base 480 that is fixed to a selected location. A mounting base cover 440 is used to cover the mounting bolts to the fixed location.

The charger provides both fast and slow charging in public and private locations. The charger is capable of recharging a plurality of vehicles such as five vehicles simultaneously with full reporting of power consumed and duration of charge cycle. All size electric vehicles from bikes to industrial vehicles to scooters, cars, trucks, and buses. Also any electronic device or gadget could receive a charge.

The charger is fully weatherized and certified under UL291 for outdoor use. The charger also includes SAE J1772 Connectivity. The charger has an embedded utility grade electronic meter. The meter provides the ability to precisely measure and report electricity use. Such meter enables a sustainable, flexible business model that meets the needs of drivers, corporations, fleet operators, utility companies and municipalities.

Payment for the charge can be received through various payment mechanisms including smart card, credit card, change, paper money, code through a key card, biometric thumb print, among others. The charger station can be used by anyone who possesses any of the above and a manual entered pin code if a smart card is utilized. The payment can be made through a revenue generating business model that includes flexible subscriber payment methods such as “free” charging, pay per use, by subscription, and by kWh (where allowed). The payment can be validated by various members such as specific chain stores that contribute or provide free charging for the advertising and PR benefit. A pay point system can be provided where pre-paid cards may be issued by the owner or by independent vendors upon receipt of payment. The station could also provide advertising through a computer screen or wall space, also providing a means of producing income. Large chain stores such as McDonalds, Starbucks, Costco, Best Buy and the like can receive large advertising benefits from advertising on and having charge stations located in their facilities.

Once the user is recognized, the charger has an on light and automatic door opening system that activates the power to the plug. Metering of power consumption is via internal smart metering system that update remotely via the mobile phone network. The metered power can by viewed online by users/members of the system and site owner. The rate can be adjusted remotely and by time of day. The rates payable per kilowatt hour (KWH) can be viewed online. During recharge an on screen display shows how much KWH is being drawn.

The system has an anti-power piracy and security circuit in one embodiment. A sensor detects if the power cable has been cut, and power ceases. A text message is sent to the user/owner to inform there has been a power interruption. A tamper alarm will sound if security of system is violated. A resettable GFI is incorporated to allow the system to recover from power surges. When current drops to near zero a text message is sent to the owner, noting the vehicle has reached full charge.

A smart controller is provided to optimize the charging schedule to minimize cost, enhance grid stability, and to safely set the maximum battery charge rate within the electrical limits of the battery, battery charger, and premises/charging station. The charger operates in a way that utilities would prefer to have it, and EV owners would prefer to have it. The smart charger controller communicates with the battery charger, charging station/premises, display, and the battery management system to set and control when and how the vehicle's battery will be charged. Utilities can target demand and respond to event to specific areas as needed.

The Smart Charger Controller implements communications through RS-232, SPI, I2C, ZigBee, and CAN 2.0 methods. The J-1772 standard assigns connector pins for vehicle to charging station/premises communication. The Smart Charger Controller design incorporates the capability to communicate using this capability. The communication interfaces include:

1. Premises/Charging Station: ZigBee and RS-232. Capability available for USB, Ethernet, and 802.11. Communicates electrical capabilities, price schedules, vehicle ID/payment authorization.

2. Battery Charger: currently CAN-bus. Capability available for USB, RS-232, RS-485, Ethernet, 802.11, and PWM. Communicates the battery charger status, battery status, and allowable charge rate information.

3. Battery Management System: currently CAN-bus. Capability available for USB, RS-232, RS-485, Ethernet, and 802.11. Communicates charging related information appropriate to the installed battery type.

4) Grid Friendly Module and External Memory: I2C or SPI. Internal communication only.

5) Display/Operator Interface: I2C, SPI, RS-485, CAN, ZigBee. Communicates owner preferences, vehicle ID/payment authorization, etc.

In one embodiment, the charging station receives power from the utility grid. In another embodiment, the charging station receives solar energy and converts solar energy into electricity. In yet another embodiment, combinations of solar charging and utility grid charging can be used.

In one embodiment, an application running on a car computer or a cell phone can locate nearest charge station via google maps or by a car GPS, among others.

In one embodiment, dependent on the location, the charging station can dispense cash and provide ATM functionality. This embodiment has all the benefits of an ATM machine and can deposit checks, withdraw limited funds. Including display, keyboard, Dip-Style card reader, dispenser, receipt printer, communication system, and security UL291 Level 1 listed vault.

The charging station can take a number of forms. In one embodiment, the charger can be an electronic parking meter. In another embodiment, the parking meter can issue a prepaid parking slip. Electronic Parking meters are receiving wider use due to their ability to increase revenues to a city or parking lot owner. By incorporating this feature the additional cost of incorporating a charging feature is minimal. In one embodiment, the system includes an illuminated display, receipt printer.

In addition to brand new charging stations, existing structures can be converted into charging stations to save money. For example, existing phone booths could be converted into charge stations. Many are located in areas where there is parking, are often located close to curbs, and they already have built-in electricity supplies and a phone wire connection. Furthermore the permit process for a standalone commercial pay device already has the necessary governmental permits and approvals needed. As a result, its cheaper to convert the booths into charging stations than to build the stations from scratch. Now with the proliferation of cell phones, many are just wasting space. The phone booth's conversion to a multi-use charge station enables the booth to become useful and income producing. Similarly, in the USA and other localities, emergency phone stations have been installed. These could be adapted to be emergency charge stations. Additionally, street lights can be converted into charging stations. Street lights have power available and with suitable minor conversions can become charging stations.

Moreover, rest stops along the highway have phone, power source, and parking and can be converted into charge stations. Other structures such as tourist information kiosks can be converted. These units often located at rest stops or a local chamber of commerce can provide another location that can be adapted as charge stations.

In use, a series of charging and parking stations or parking meters are placed at a location along a street or a parking facility and supplying alternating current, as for example, 120 or 240 volt A.C., thereto. In one embodiment, the electric vehicles have distributed chargers, one for each group of batteries, for converting the alternating current energy available at the meter structures to direct current and for controlling the state of charge of the vehicle batteries. The distributed chargers enable each group of batteries to be charged separately, thus avoiding the bottleneck of one set of battery slowing down the charging of another set. Also, power can be provided in parallel rather than sequentially.

Preferably, a wireless control device in the car transmits financial information to the meter to enable power to be provided to the charging cord plug to the meter. In one embodiment, the wireless control device can be a cell phone communicating with the meter of FIG. 3 using Bluetooth, ZigBee (802.15) or WiFi (802.11). Alternatively, to facilitate use by one time users who do not have an account, the charging can be facilitated by inserting a charge card into the meter and connecting the electric vehicle's charging cord plug to the meter.

A plurality of voltage sources, for example, 120 and 240 volt A.C. outlets, respectively, can be provided at the meter of FIG. 3. The voltage sources 324 and 326 are provided with a sliding cover 328 so that only one will be available at any one time, and are further provided with a separate spring loaded cover 329 to protect the voltage sources when not in use. A ground fault interrupter breaker is provided in the meter post 480 with access through a post door.

The meter includes a display to provide user feedback. The display can be a touch screen display to capture user input as well. The meter structure 312 includes the separate operational display structure and numeric display structure, also includes the plug lock mechanism and card reader. The plug lock mechanism is operable on an instruction from the wireless transceiver on the vehicle or on the first insertion of a charge card to lock a vehicle's electric charging cord plug to the meter structure and to release the plug from the meter structure on the second insertion of a charge card in the meter. The card reader functions to identify the presence of a card in the meter and to validate the card in accordance with identification parameters on the card.

The electric vehicle charging and parking meter system structure includes an overload detector for sensing charging circuit overloads, an open circuit detector for sensing an open charging circuit, a kilowatt transducer for determining energy used in charging of the electric vehicle, and a time clock for aiding in the determination of the energy used in charging the vehicle, and in determination of the time of parking the vehicle. A power breaker is provided for connecting and disconnecting the power to the electric vehicle being charged. The breaker is activated or deactivated by customer request or a system fault.

A series of charging and parking meters can be connected to a single microprocessor unit, which unit could be contained in one of the charging and parking meter enclosures to serve more than one charging and parking meter, or could be located in a nearby protected area to serve a group of charging and parking meters.

The charging and parking meters may be made to service, one, two or more electric automobiles. The charging and parking meters would function as a means of charging electric batteries when the owners are away from their residence. It is therefore hypothesized that the charging and parking meters would be located at shopping centers, indoor and outdoor theaters, parking garages, on-street and off-street parking spaces, or any other location where an electric vehicle owner may park for an extended time. Thus, the range of an electric vehicle can be extended considerably.

In one embodiment, each of batteries has a built in charger and a switch to isolate each battery to enable rapid parallel charging from one power cable. During such parallel charging, each battery is charged independent of the others. A master charging controller controls and coordinates the chargers to ensure quick charging. Battery-monitoring systems can monitor the battery's state of charge, which in turn determines the battery's cost and performance. By knowing the battery's state of charge, the system can use more capacity from each cell, use fewer cells, and maximize the lifetimes of those cells. Voltage, current, charge, temperature can provide a good indication of the state of charge. The charging/discharging of series-connected cells must stop when any cell reaches its maximum or minimum allowable state of charge. The system keeps the capacity levels the same in all cells over time and helps them age in unison. The battery-monitoring system can tweak the charge level in each cell to derive more energy and greater lifetime from the pack. Cell balancing is a critical feature in EVs and HEVs.

In one embodiment, a passive-balancing technique places a bleed resistor across a cell when its state of charge exceeds that of its neighbors. Passive balancing doesn't increase the drive distance after a charge because the technique dissipates, rather than redistributes, power. In another embodiment, active balancing is used so that charge shuttles between cells and does not end up as wasted heat. This approach requires a storage element such as capacitors, inductors, or transformers for the charge transfer. The capacitor continuously switches between two adjacent cells. Current flows to equalize the voltage and, therefore, the state of charge of the two cells. Using a bank of switches and capacitors, the voltage of all cells tends to equalize. The circuit continuously balances cells in the background as long as the switching clock is active. A transformer-based scheme transfers charge between a single cell and a group of cells. The scheme requires state-of-charge information to select the cell for charging and discharging to and from the group of six cells.

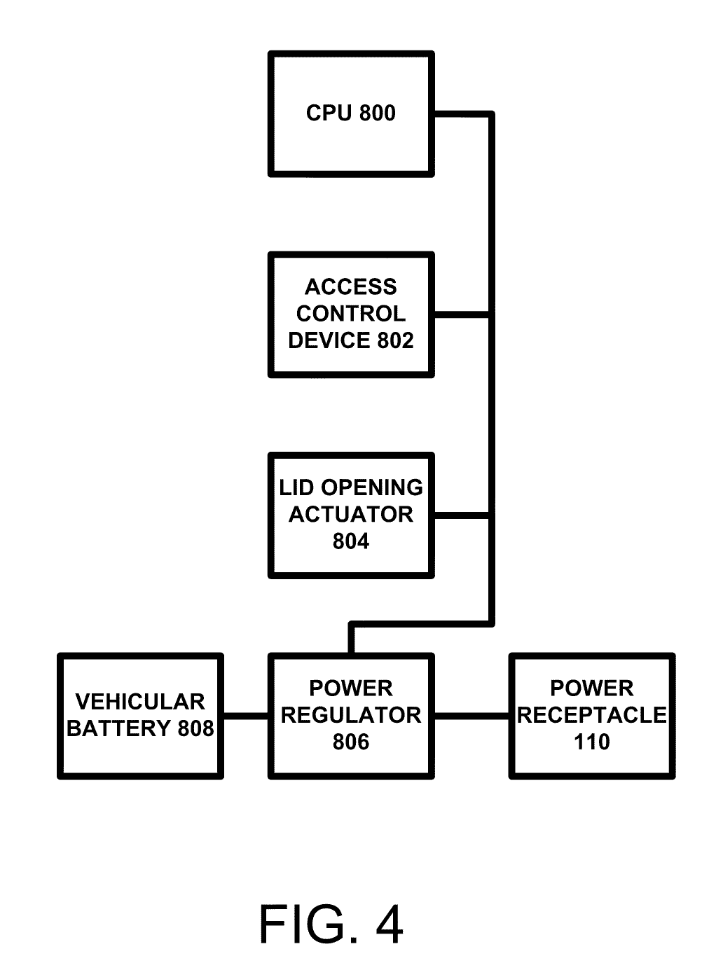

FIG. 4 shows exemplary power recharging circuitry in the vehicle. A processor 800 communicates with an access control device 802 over a bus. The access control device 802 can be a credit/debit card reader, a smart cart, a proximity card, RFID, smart card, credit card, or pin pad code, among others. The access control device 802 receives input from the user to authorize charging, and upon authorization, the processor 800 causes the lid opening actuator 804 to open the lid 102 to allow electrical access to the power receptacle 110. The processor 800 enables a power regulator 806 to charge a set of vehicular batteries 808. The batteries can be charged as one group, or as a set of parallel batteries independently charged for quick charging purposes.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A recharging port for an electric vehicle, comprising:
a recharging lid having a latch to secure the recharging lid to the recharging port when the lid is closed, the lid having a power line cable exit with a curved finger receiving space;
an arm coupled to the recharging lid to open the recharging lid; and
a power receptacle recessed in the recharging port to provide power to recharge one or more batteries in the electric vehicle.

2. The recharging port of claim 1, comprising an access control device to read authorization information from a proximity card, RFID, smart card, credit card, or pin pad code, the access control device adapted to unlock the latch to open the recharging lid and to receive power upon authorization.

3. The recharging port of claim 2, wherein the access control device is in the electric vehicle.

4. The recharging port of claim 1, comprising an access control device to read authorization information from a proximity card, RFID, smart card, credit card, or pin pad code, the access control device adapted to unlock a door in a recharging station to provide recharging power to the vehicle upon authorization.

5. The recharging port of claim 4, wherein the access control device is on the recharging station.

6. The recharging port of claim 1, comprising an access control device to read authorization information from a proximity card, RFID, smart card, credit card, or pin pad code, the access control device adapted to unlock the latch to open the recharging lid and to receive power upon authorization, the access control device further adapted to unlock a door in a recharging station to provide recharging power to the vehicle upon authorization.

7. The recharging port of claim 6, wherein the access control device is on the recharging station.

8. The recharging port of claim 6, wherein the access control device is in the vehicle.

9. A recharging station, comprising:
a power receptacle adapted to recharge a vehicle battery;
an electrically-controlled door to control access to the power receptacle; and
an access control device to open the door and to supply power to the power receptacle after authorization.

10. The recharging station of claim 9, comprising an indicator light coupled to the access control device to indicate authorization and activation of power to the power receptacle.

11. The recharging station of claim 9, comprising a plurality of power connections to distribute electricity to charge in parallel a plurality of battery sets in a vehicle.

12. The recharging station of claim 9, wherein the access control device reads a credit card and charges the credit card prior to opening the door and supplying power to the power receptacle.

13. The recharging station of claim 9, wherein the access control device reads a smart card and charges the smart card prior to opening the door and supplying power to the power receptacle.

14. The recharging station of claim 9, wherein the access control device reads a code or password from a user and opens the door and supplies power to the power receptacle.

15. The recharging station of claim 9, wherein the access control device reads a biometric scan or a thumb print of a user and opens the door and supplies power to the power receptacle.

16. The recharging station of claim 9, wherein the access control device opens a recharging lid having a latch to secure the recharging lid to the recharging port when the lid is closed, comprising a power cable coupling the power receptacle on the recharging station to a power receptacle recessed in the recharging port to provide power to recharge one or more batteries in the electric vehicle.

17. A system, comprising:
a vehicle having a recharging lid having a latch to secure the recharging lid to the recharging port when the lid is closed; an arm coupled to the recharging lid to open the lid; and a power receptacle recessed in the recharging port to provide power to recharge one or more batteries in the electric vehicle; and
a recharging station, including a power receptacle adapted to recharge a vehicle battery; an electrically-controlled door to control access to the power receptacle; and an access control device to open the door and to supply power to the power receptacle after authorization.

19. The system of claim 17, comprising a transceiver in the recharging station to send status of components in the vehicle to a remote computer.

20. The system of claim 17, wherein each set of batteries is electrically isolated during charging and electrically connected thereafter.
